(19) United States
(12) Patent Application Publication
(10) Pub. No.: US 2024/0116477 A1
(43) Pub. Date: Apr. 11, 2024

(54) SERVER, SYSTEM, AND MANAGEMENT METHOD

(71) Applicant: TOYOTA JIDOSHA KABUSHIKI KAISHA, Toyota-shi (JP)

(72) Inventors: Yuko TERASAWA, Tokyo-to (JP); Makoto KAKUCHI, Toyota-shi (JP); Toshiaki KARASAWA, Tokyo-to (JP); Takeshi HIGASHI, Nagoya-shi (JP); Yoshihiko ENDO, Minato-ku (JP)

(73) Assignee: TOYOTA JIDOSHA KABUSHIKI KAISHA, Toyota-shi (JP)

(21) Appl. No.: 18/480,617

(22) Filed: Oct. 4, 2023

(30) Foreign Application Priority Data
Oct. 5, 2022 (JP) 2022-161200

(51) Int. Cl. B60S 5/06; B60L 53/63; B60L 53/80

(52) U.S. Cl. CPC B60S 5/06; B60L 53/63; B60L 53/80

(57) ABSTRACT

A server includes a communication unit (first communication unit) (second communication unit) that receives information about a request for adjustment of power supply-and-demand in a power grid. The server includes a processor (controller) that predicts a schedule of replacement of a battery (first battery) at a battery station (battery replacement apparatus). The processor specifies, based on the schedule, a battery (second battery) available for charging or discharging for the request for adjustment, and determines, based on the specified battery, whether or not it is possible to respond to the request for adjustment.

### CROSS REFERENCE TO RELATED APPLICATIONS

This nonprovisional application is based on Japanese Patent Application No. 2022-161200 filed on Oct. 5, 2022 with the Japan Patent Office, the entire contents of which are hereby incorporated by reference.

### BACKGROUND

### Field

The present disclosure relates to a server, a system, and a management method.

### Description of the Background Art

WO2019/159475 discloses that a battery of an electrically powered vehicle is replaced at a battery station. While not disclosed in the above-referenced WO2019/159475, batteries provided in the battery station may be used to perform VPP (Virtual Power Plant) control. VPP control means adjustment of power supply-and-demand in a power grid, based on power generation and power consumption by each power adjustment resource.

### SUMMARY

Batteries provided in the battery station are used for replacement with batteries of electrically powered vehicles as described above, and therefore, the batteries provided in the battery station vary in terms of the battery type, the number of batteries, and the total charge amount of the batteries, for example. It is therefore difficult, in some cases, to determine whether or not VPP control can be performed using the batteries provided in the battery station. Hence, there is a demand for a server and a system that enable a determination to be made easily as to whether or not VPP control can be performed using batteries provided in a battery station (battery replacement apparatus).

The present disclosure is given for solving the above problem, and an object of the present disclosure is to provide a server, a system, and a management method that enable a determination to be made easily as to whether or not VPP control can be performed using batteries provided in a battery replacement apparatus.

A server according to a first aspect of the present disclosure is a server that manages a battery replacement apparatus provided with at least one battery replaceable with a battery mounted on at least one electrically powered vehicle, the battery mounted on the at least one electrically powered vehicle being first battery, the at least one battery provided in the battery replacement apparatus being second battery, the server includes: a first communication unit that receives information about a request for adjustment of power supply-and-demand in a power grid; and a controller that predicts a schedule of replacement of the first battery at the battery replacement apparatus. The controller specifies, based on the schedule, the second battery available for charging or discharging for the request for adjustment, and determines, based on the specified second battery, whether or not it is possible to respond to the request for adjustment.

In the server according to the first aspect of the present disclosure, the second battery available for charging or discharging for the request for adjustment is specified based on the schedule of replacement of the first battery, and it is determined whether or not it is possible to respond to the request for adjustment, based on the specified second battery, as described above. Thus, based on the schedule, the controller can easily recognize the capacity of charging or discharging (capacity of VPP control) at the battery replacement apparatus. As a result, it is possible to easily determine whether or not VPP control can be performed with the battery provided in the battery replacement apparatus.

In the server according to the first aspect, the controller detects a first number of the at least one electrically powered vehicle around the battery replacement apparatus, and predicts the schedule of replacement of the first battery based on the first number, as described above. With such a configuration, it is possible to easily predict the schedule, based on the first number of electrically powered vehicles around the battery replacement apparatus.

In this case, preferably a first memory in which a first vehicle number estimation model is stored is further included. The first vehicle number estimation model is a trained model, the trained model inputting the first number and outputting a value based on a second number of the at least one electrically powered vehicle having used the battery replacement apparatus, out of the first number. The controller predicts the schedule based on the first vehicle number estimation model and the first number. With such a configuration, it is possible to accurately predict the schedule based on the first vehicle number estimation model.

The server predicting the schedule based on the number of electrically powered vehicles around the battery replacement apparatus preferably further includes a second communication unit that receives positional information about the at least one electrically powered vehicle. The controller detects the first number based on the positional information. With such a configuration, it is possible to easily obtain the information about the first number of electrically powered vehicles, based on the positional information about the electrically powered vehicle that is obtained through communication.

The server according to the first aspect further includes a second memory in which a second vehicle number estimation model is stored, as described above. The second vehicle number estimation model is a trained model, the trained model inputting information about date and outputting a value based on a third number of the at least one electrically powered vehicle that uses the battery replacement apparatus on the date. The controller predicts the schedule based on the second vehicle number estimation model and the information about the date. With such a configuration, it is possible to predict the schedule, without detecting the number of electrically powered vehicles around the battery replacement apparatus.

In the server according to the first aspect, preferably the controller determines, based on an SOC of the specified second battery, whether or not it is possible to respond to the request for adjustment. With such a configuration, it is possible to more accurately recognize the capacity of charging or discharging at the battery replacement apparatus, based on the SOC of the specified second battery.

In this case, preferably the controller calculates a total chargeable amount or a total dischargeable amount of the second battery, based on the SOC of the specified second battery, and determines, based on the total chargeable amount or the total dischargeable amount, whether or not it is possible to respond to the request for adjustment. With such a configuration, the controller can more accurately recognize the capacity of charging or discharging at the battery replacement apparatus, based on the total chargeable amount or the total dischargeable amount of the second battery.

A system according to a second aspect of the present disclosure includes: a battery replacement apparatus provided with at least one battery replaceable with a battery mounted on at least one electrically powered vehicle, the battery mounted on the at least one electrically powered vehicle being first battery, the at least one battery provided in the battery replacement apparatus being second battery; and a server that manages the battery replacement apparatus. The server includes: a communication unit that receives information about a request for adjustment of power supply-and-demand in a power grid; and a controller that predicts a schedule of replacement of the first battery at the battery replacement apparatus. The controller specifies, based on the schedule, the second battery available for charging or discharging for the request for adjustment, and determines, based on the specified second battery, whether or not it is possible to respond to the request for adjustment.

In the system according to the second aspect of the present disclosure, the second battery available for charging or discharging for the request for adjustment is specified based on the schedule of replacement of the first battery, and it is determined whether or not it is possible to respond to the request for adjustment, based on the specified second battery, as described above. Thus, it is possible to provide a system that can easily determine whether or not VPP control can be performed with the battery provided in the battery replacement apparatus.

A management method according to a third aspect of the present disclosure is a management method for managing a battery replacement apparatus provided with at least one battery replaceable with a battery mounted on at least one electrically powered vehicle, the battery mounted on the at least one electrically powered vehicle being first battery, the at least one battery provided in the battery replacement apparatus being second battery, the management method includes: receiving information about a request for adjustment of power supply-and-demand in a power grid; predicting a schedule of replacement of the first battery at the battery replacement apparatus; specifying, based on the schedule, the second battery available for charging or discharging for the request for adjustment; and determining, based on the specified second battery, whether or not it is possible to respond to the request for adjustment.

With the management method according to the third aspect of the present disclosure, the second battery available for charging or discharging for the request for adjustment is specified based on the schedule of replacement of the first battery, and it is determined whether or not it is possible to respond to the request for adjustment, based on the specified second battery, as described above. Thus, it is possible to provide a management method that enables a determination to be made easily as to whether or not VPP control can be performed with the battery provided in the battery replacement apparatus.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 shows a configuration of a system according to one embodiment.

FIG. 2 shows an example of a configuration of a battery station according to one embodiment.

FIG. 3 shows functional features of a processor according to one embodiment.

FIG. 4 shows a method for predicting a schedule of battery replacement by the processor according to one embodiment.

FIG. 5 is a sequence diagram showing sequence control by a server according to one embodiment.

FIG. 6 shows a method for predicting a schedule of battery replacement by the processor according to a modification of one embodiment.

### DESCRIPTION OF THE PREFERRED EMBODIMENTS

Embodiments of the present disclosure are described hereinafter with reference to the drawings. In the drawings, the same or corresponding parts are denoted by the same reference characters, and a description thereof is not herein repeated.

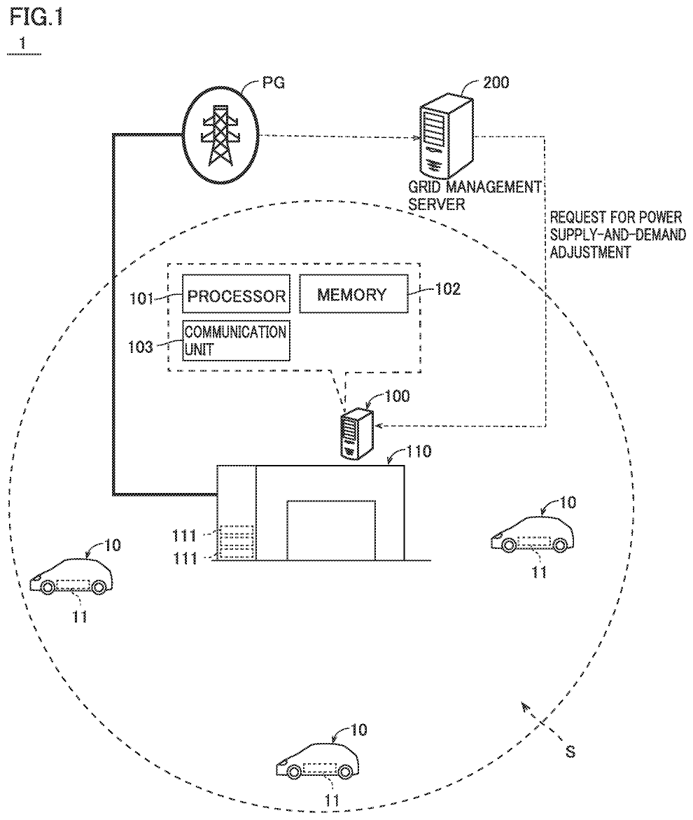

FIG. 1 shows a configuration of a system 1 according to the present embodiment. System 1 includes a server 100, a battery station 110, a grid management server 200, and a power grid PG. Server 100 manages battery station 110. Server 100 may be provided at battery station 110. Battery station 110 is an example of “battery replacement apparatus” of the present disclosure.

Battery station 110 is provided with a plurality of batteries 111. At battery station 110, a battery 11 mounted on an electrically powered vehicle 10 is replaced with battery 111. Battery 11 and battery 111 are respective examples of “first battery” and “second battery” of the present disclosure, respectively.

Electrically powered vehicle 10 includes, for example, PHEV (Plug-in Hybrid Electric Vehicle), BEV (Battery Electric Vehicle), and FCEV (Fuel Cell Electric Vehicle). Electrically powered vehicle 10 may include DCM (Data Communication Module) or include a communication I/F compatible with the 5G (fifth generation mobile communication system).

Power grid PG is a power network made up of a power plant and a power transmission and distribution facility (not shown). In this embodiment, an electric power company serves as both a power generation entity and a power transmission and distribution entity. The electric power company corresponds to a general power transmission and distribution entity, and maintains and manages power grid PG. The electric power company corresponds to an administrator of power grid PG.

Grid management server 200 manages power supply-and-demand in power grid PG (power network). Grid management server 200 belongs to the electric power company. Grid management server 200 transmits, to server 100, a request for adjustment of the amount of power demand for power grid PG (power supply-and-demand adjustment request), based on power generation and power consumption by each power adjustment resource managed by grid management server 200. Specifically, when the power generation or power consumption of the power adjustment resource is assumed to be larger (or is currently larger) than the normal one, grid management server 200 transmits a request, to server 100, to make the amount of power demand larger or smaller than the normal one.

Server 100 is a server managed by an aggregator. The aggregator refers to an electricity entity that aggregates a plurality of power adjustment resources such as local and/or predetermined facilities and offers an energy management service.

Server 100 uses battery 111 in battery station 110 as one means for increasing or decreasing the amount of power demand for power grid PG to perform power feeding to power grid PG (external power feeding) and charging from power grid PG (external charging).

Server 100 is also configured to manage information about a plurality of registered electrically powered vehicles 10 (hereinafter also referred to as “vehicle information”), and information about each registered user (hereinafter also referred to as “user information”). The user information and the vehicle information are each distinguished by identification information (ID) and stored in a memory 102 described later herein.

Vehicle ID is identification information for identifying electrically powered vehicle 10. The vehicle ID may be a number plate or VIN (Vehicle Identification Number). The vehicle information includes an action schedule of each electrically powered vehicle 10.

Server 100 includes a processor 101, memory 102, and a communication unit 103. Processor 101 controls communication unit 103. Memory 102 stores, in addition to a program to be executed by processor 101, information (for example, map, formula, and various parameters) to be used by the program. Memory 102 is an example of “first memory” of the present disclosure.

Communication unit 103 of server 100 communicates with each of grid management server 200 and a plurality of electrically powered vehicles 10. Communication unit 103 includes various communication I/Fs. Communication unit 103 is an example of “first communication unit” and “second communication unit” of the present disclosure.

Communication unit 103 of server 100 receives, from grid management server 200, information about a request for adjustment of power supply-and-demand in power grid PG. Communication unit 103 of server 100 also communicates with each of a plurality of electrically powered vehicles 10 to receive positional information about each of the plurality of electrically powered vehicles 10.

Memory 102 also stores information (such as SOC and degree of degradation) about each of a plurality of batteries 111 provided in battery station 110. The information (such as SOC and degree of degradation) about battery 11 that is stored in battery station 110 from electrically powered vehicle 10, as a result of battery replacement, is stored in memory 102.

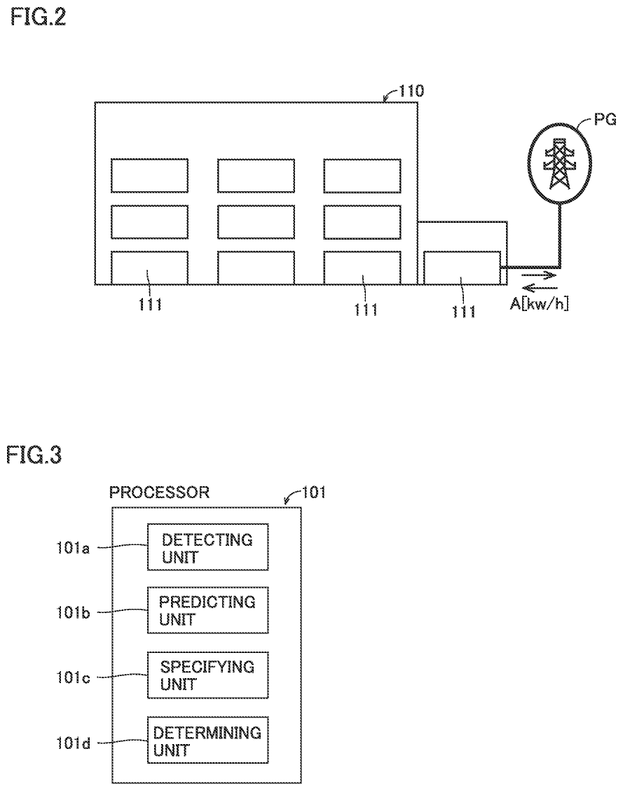

FIG. 2 shows a detailed configuration of battery station 110. In the example shown in FIG. 2, external charging or external power feeding is being performed using one of a plurality of (ten in FIG. 2) batteries 111 provided in battery station 110. In battery station 110, external charging or external power feeding is performed for each battery 111. It is assumed that, in battery station 110, power in AkW can be transferred per hour between battery 111 and power grid PG. In battery station 110, a plurality of batteries 111 may be used simultaneously for external power feeding or external charging.

As shown in FIG. 3, processor 101 includes a detecting unit 101a, a predicting unit 101b, a specifying unit 101c, and a determining unit 101d. Each of detecting unit 101a, predicting unit 101b, specifying unit 101c, and determining unit 101d represents software in the form of a block for a respective functional feature of processor 101.

Processor 101 (detecting unit 101a) detects the number of electrically powered vehicles 10 around battery station 110, based on the positional information about electrically powered vehicles 10 acquired by communication unit 103. Specifically, processor 101 (detecting unit 101a) detects the number of electrically powered vehicles in a region S (see FIG. 1) within a predetermined radius (for example, 10 km) about battery station 110.

Processor 101 (predicting unit 101b) predicts a schedule of replacement of battery 11, based on the detected number of electrically powered vehicles 10. For example, a trained model generated by the technique of machine learning such as deep learning can be used for the prediction process.

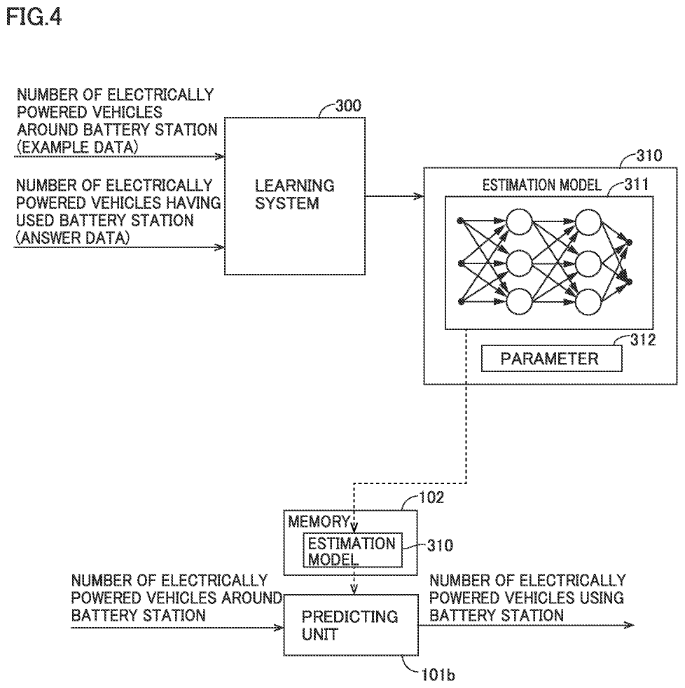

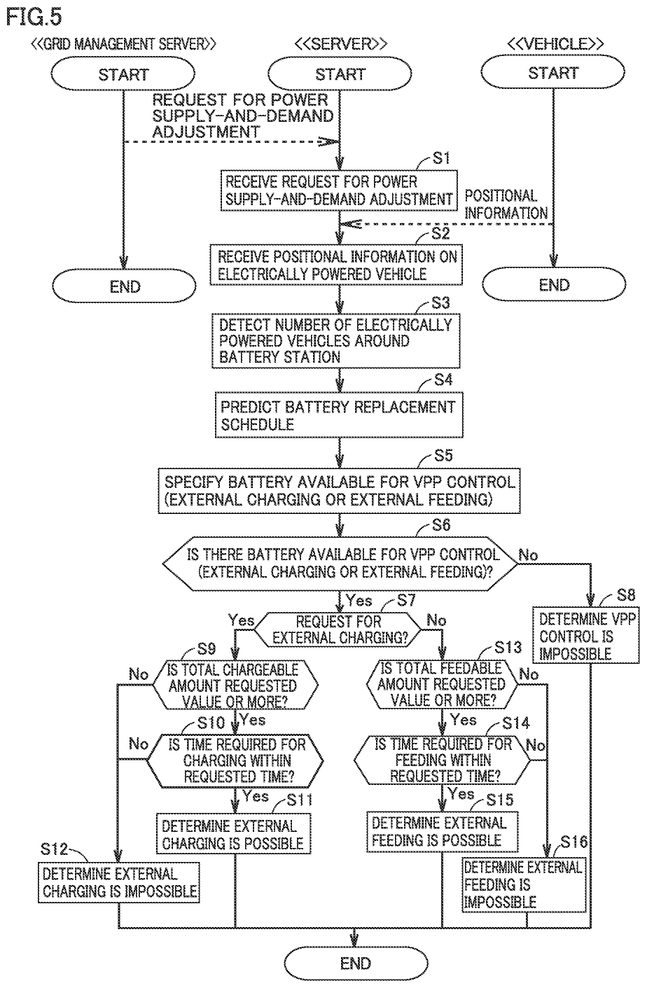

FIG. 4 illustrates an example of a trained model used for predicting the schedule. An estimation model 310, which is a pre-trained model, includes, for example, a neural network 311 and a parameter 312. Neural network 311 is a known neural network used for processing by deep learning. Examples of such a neural network include convolutional neural network (CNN), recurrent neural network (RNN), and the like. Parameter 312 includes, for example, weighting coefficient used for arithmetic operation by neural network 311. Estimation model 310 is an example of “first vehicle number estimation model” of the present disclosure.

Many teacher data are prepared in advance by a developer. The teacher data include example data and answer data. The example data is data of the number of electrically powered vehicles 10 around battery station 110 (an example of “first number” of the present disclosure). The answer data is data of the number of electrically powered vehicles 10 that have used battery station 110, out of the number of electrically powered vehicles 10 around battery station 110. Learning system 300 trains estimation model 310 using the example data and the answer data.

Thus, estimation model 310 is trained, and estimation model 310 on which the training is completed is stored in memory 102. Then, processor 101 (predicting unit 101b) outputs the number of electrically powered vehicles 10 that use battery station 110, based on estimation model 310 and the number of electrically powered vehicles 10 around battery station 110. The schedule is predicted in this way. Even after estimation model 310 is stored in memory 102, training on estimation model 310 may be continued based on the result of prediction by predicting unit 101b.

Batteries provided in the battery station are used for replacement, and therefore, the batteries provided in the battery station vary in terms of the battery type, the number of batteries, and the total charge amount of the batteries, for example. It is therefore difficult in some cases for the conventional system to determine whether or not VPP control can be performed using the batteries provided in the battery station. Hence, there is a demand for a server and a system that enable a determination to be made easily as to whether or not VPP control can be performed using batteries provided in a battery station.

In view of the above, in the present embodiment, processor 101 (specifying unit 101c) specifies battery 111 available for external charging or external power feeding for the request for adjustment of power supply-and-demand in power grid PG, based on the schedule of replacement of battery 11. Processor 101 (determining unit 101d) determines whether or not it is possible to respond to the request for adjustment, based on specified battery 111.

In battery station 110, battery 111 charged to an SOC of 100% is used for replacement with battery 11 of electrically powered vehicle 10. It is therefore necessary for battery station 110 to charge battery 111 before replacement with another battery. Then, processor 101 (specifying unit 101c) preferentially selects battery 111 having a high SOC among a plurality of batteries 111 provided in battery station 110, for replacement with battery 11 of electrically powered vehicle 10. It is therefore possible to suppress increase in the amount of electric power used for charging battery 111. Then, processor 101 (specifying unit 101c) specifies battery 111 other than battery 111 selected for replacement with battery 11 of electrically powered vehicle 10, as a battery 111 available for external charging or external power feeding.

The method for specifying battery 111 available for external charging or external power feeding is not limited to the above example. For example, processor 101 (specifying unit 101c) may preferentially select battery 111 having a low degree of degradation, among a plurality of batteries 111 provided in battery station 110, for replacement with battery 11 of electrically powered vehicle 10.

Processor 101 (determining unit 101d) determines whether or not it is possible to respond to the request for adjustment of power supply-and-demand in power grid PG, based on the SOC of battery 111 specified as battery 111 available for external charging or external power feeding. Specifically, processor 101 (determining unit 101d) calculates, based on the SOC of specified battery 111, the total chargeable amount or total dischargeable (feedable) amount of battery 111, and determines whether or not it is possible to respond to the request for adjustment, based on the total chargeable amount or total dischargeable (feedable) amount. The total chargeable amount or total dischargeable amount is calculated based on the SOC information about battery 111 stored in memory 102. The method for this determination is described later herein with reference to the sequence diagram of FIG. 5.

Sequence Control by Server

Next, with reference to FIG. 5, sequence control for determining whether or not VPP control can be performed by server 100 is described.

In step S1, communication unit 103 of server 100 receives a request regarding adjustment of power supply-and-demand in power grid PG, from grid management server 200.

In step S2, communication unit 103 of server 100 receives positional information on electrically powered vehicle 10, from each of a plurality of electrically powered vehicles 10.

In step S3, processor 101 (detecting unit 101a) detects the number of electrically powered vehicles 10 in region S (see FIG. 1) around battery station 110, based on the positional information received in step S2.

In step S4, processor 101 (predicting unit 101b) predicts a schedule of battery replacement with battery 11 of electrically powered vehicle 10, based on the result of detection in step S3. Processor 101 (predicting unit 101b) predicts the schedule based on a result of training through machine learning as described above.

In step S5, processor 101 (specifying unit 101c) specifies battery 111 that is available for VPP control (external charging or external power feeding), based on the schedule predicted in step S4.

In step S6, processor 101 (determining unit 101d) determines whether or not there is (one or more) batteries 111 in battery station 110 that are available for VPP control (external charging or external power feeding). When there is battery 111 that enables VPP control (Yes in S6), the process proceeds to step S7. When there is no battery 111 that enables VPP control (No in S6), the process proceeds to step S8.

In step S7, processor 101 (determining unit 101d) determines whether or not the request for adjustment of power supply-and-demand received in step S1 is a request for external charging. When the request for adjustment of power supply-and-demand is a request for external charging (Yes in S7), the process proceeds to step S9. When the request for adjustment of power supply-and-demand is not a request for external charging (No in S7), the process proceeds to step S13. The fact that the request for adjustment of power supply-and-demand is not a request for external charging means that the request for adjustment of power supply-and-demand is a request for external power feeding.

In step S8, processor 101 (determining unit 101d) determines that VPP control that meets the request for adjustment of power supply-and-demand is impossible. The process is thereafter ended.

In step S9, processor 101 (determining unit 101d) determines whether or not the total chargeable amount of battery 111 specified in step S5 is more than or equal to the amount of electric power (requested value of external charging) that satisfies the request for adjustment of power supply-and-demand in step S1. Specifically, processor 101 (determining unit 101d) determines whether or not the total value of power-chargeable capacity of specified battery 111 is more than or equal to the requested value. When the total chargeable amount is more than or equal to the requested value (Yes in S9), the process proceeds to step S10. When the total chargeable amount is smaller than the requested value (No in S9), the process proceeds to step S12.

In step S10, processor 101 (determining unit 101d) determines whether or not the time required for charging power (requested amount, herein denoted by X) that satisfies the request for adjustment of power supply-and-demand falls within the time (requested time, herein denoted by T1) required for satisfying the request for adjustment of power supply-and-demand. Specifically, processor 101 (determining unit 101d) determines whether or not a value (X/A) determined by dividing the requested amount by the chargeable amount per hour (AkW, see FIG. 2) is less than or equal to the requested time (X/A≤T1). When the quotient is less than or equal to the requested time (Yes in S10), the process proceeds to step S11. When the quotient is greater than the requested time (No in S10), the process proceeds to step S12. The time required for charging may include the time required for replacing battery 111 to be charged in battery station 110 (the time required for transporting battery 111).

In step S11, processor 101 (determining unit 101d) determines that external charging that satisfies the request for adjustment of power supply-and-demand is possible. After this, the process is ended.

In step S12, processor 101 (determining unit 101d) determines that external charging that satisfies the request for adjustment of power supply-and-demand is impossible. After this, the process is ended.

In step S13, processor 101 (determining unit 101d) determines whether or not the total feedable (dischargeable) amount of battery 111 specified in step S5 is more than or equal to the amount of electric power (requested value of external power feeding) satisfying the request for adjustment of power supply-and-demand in step S1. Specifically, processor 101 (determining unit 101d) determines whether or not the total value of the amount of electric power of specified battery 111 is more than or equal to the requested value. When the total feedable amount is greater than or equal to the requested value (Yes in S13), the process proceeds to step S14. When the total feedable amount is smaller than the requested value (No in S13), the process proceeds to step S16.

In step S14, processor 101 (determining unit 101d) determines whether or not the time required for feeding power (requested amount, herein denoted by Y) that satisfies the request for adjustment of power supply-and-demand falls within the time (requested time, herein denoted by T2) that satisfies the request for adjustment of power supply-and-demand. Specifically, processor 101 (determining unit 101d) determines whether or not a value (Y/A) determined by dividing the requested amount by the feedable amount per hour (AkW, see FIG. 2) is less than or equal to the requested time (Y/A T2). When the quotient is less than or equal to the requested time (Yes in S14), the process proceeds to step S15. When the quotient is greater than the requested time (No in S14), the process proceeds to step S16. The time required for power feeding may include the time required for replacing battery 111 to be fed with power in battery station 110 (the time required for transporting battery 111).

In step S15, processor 101 (determining unit 101d) determines that external power feeding that satisfies the request for adjustment of power supply-and-demand is possible. After this, the process is ended.

In step S16, processor 101 (determining unit 101d) determines that external power feeding that satisfies the request for adjustment of power supply-and-demand is impossible. After this, the process is ended.

As seen from the above, in the above embodiment, processor 101 predicts a schedule of replacement of battery 11 based on the number of electrically powered vehicles 10 around battery station 110, and specifies, based on the schedule, battery 111 available for charging or discharging for the request for adjustment of power supply-and-demand. Then, processor 101 determines whether or not it is possible to respond to the request for adjustment of power supply-and-demand, based on specified battery 111. This makes it possible to clarify the capacity of external charging (power feeding) of battery station 110, based on the schedule. As a result, it is possible to appropriately determine whether or not it is possible to respond to the request for adjustment of power supply-and-demand.

While an example is illustrated above in connection with the above-described embodiment where it is determined whether or not it is possible to respond to the request for adjustment of power supply-and-demand, based on the SOC of battery 111 specified as the one available for VPP control, the present disclosure is not limited to this. For example, it may be determined whether or not it is possible to respond to the request for adjustment of power supply-and-demand, based on the number of batteries 111 specified as available for VPP control.

While an example is illustrated above in connection with the above-described embodiment where the number of electrically powered vehicles 10 around battery station 110 is detected based on the positional information about electrically powered vehicle 10 obtained through communication with electrically powered vehicle 10, the present disclosure is not limited to this. For example, based on an image of a camera installed at battery station 110 or in the vicinity of battery station 110, the number of electrically powered vehicles 10 around battery station 110 may be detected.

While an example is illustrated above in connection with the above-described embodiment where it is determined whether or not it is possible to respond to the request for adjustment of power supply-and-demand, based on the SOC of battery 111 specified as the one available for VPP control, the present disclosure is not limited to this. For example, whether or not it is possible to respond to the request for adjustment of power supply-and-demand may be determined, based on the sum of the SOC of specified battery 111 and the SOC of battery 11 to be replaced with battery 111 and stored in battery station 110.

While an example is illustrated above in connection with the above-described embodiment where a trained model generated by the technique of machine learning such as deep learning is used for prediction of a schedule of the battery replacement, the present disclosure is not limited to this. The trained model may not be used for prediction of the battery replacement schedule. For example, a certain ratio may be defined that is the ratio of the number of electrically powered vehicles 10 of which batteries are expected to be replaced at battery station 110, to the number of electrically powered vehicles 10 around battery station 110.

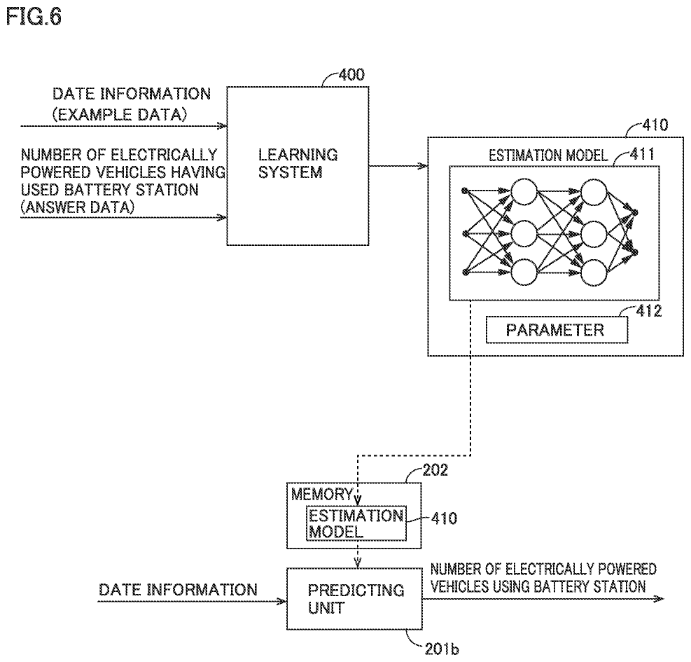

While an example is illustrated above in connection with the above-described embodiment where a schedule of battery replacement is predicted based on the number of electrically powered vehicles 10 around battery station 110, the present disclosure is not limited to this. For example, a trained model (estimation model) generated by the technique of machine learning based on date information may be used for predicting the schedule. Specifically, estimation model 410 trained by learning system 400 (see FIG. 6) with example data that is information about the date and answer data that is the number of electrically powered vehicles 10 that have used battery station 110 for each date may be used to predict the schedule. Estimation model 410 which is a pre-trained model includes neural network 411 and parameter 412, for example.

Thus, training on estimation model 410 is performed and estimation model 410 on which training is completed is stored in memory 202. Based on estimation model 410 and date information, the processor (predicting unit 201b) outputs the number of electrically powered vehicles 10 that use battery station 110. In this way, the schedule is predicted. Even after estimation model 410 is stored in memory 102, training on estimation model 410 may be continued based on the result of the prediction. Memory 202 and estimation model 410 are respective examples of “second memory” and “second vehicle number estimation model” of the present disclosure, respectively.

While embodiments of the present disclosure have been illustrated, it should be construed that the embodiments disclosed herein are given by way of illustration in all respects, not by way of limitation. It is intended that the scope of the present disclosure is defined by claims, and encompasses all modifications equivalent in meaning and scope to the claims.

What is claimed is:

1. A server that manages a battery replacement apparatus provided with at least one battery replaceable with a battery mounted on at least one electrically powered vehicle, the battery mounted on the at least one electrically powered vehicle being first battery, the at least one battery provided in the battery replacement apparatus being second battery, the server comprising:
a first communication unit that receives information about a request for adjustment of power supply-and-demand in a power grid; and
a controller that predicts a schedule of replacement of the first battery at the battery replacement apparatus, wherein
the controller
specifies, based on the schedule, the second battery available for charging or discharging for the request for adjustment, and
determines, based on the specified second battery, whether or not it is possible to respond to the request for adjustment.

2. The server according to claim 1, wherein the controller detects a first number of the at least one electrically powered vehicle around the battery replacement apparatus, and predicts the schedule of replacement of the first battery based on the first number.

3. The server according to claim 2, further comprising a first memory in which a first vehicle number estimation model is stored, wherein
the first vehicle number estimation model is a trained model, the trained model inputting the first number and outputting a value based on a second number of the at least one electrically powered vehicle that uses the battery replacement apparatus, out of the first number, and
the controller predicts the schedule based on the first vehicle number estimation model and the first number.

4. The server according to claim 2, further comprising a second communication unit that receives positional information about the at least one electrically powered vehicle, and
the controller detects the first number based on the positional information.

5. The server according to claim 1, further comprising a second memory in which a second vehicle number estimation model is stored, wherein
the second vehicle number estimation model is a trained model, the trained model inputting information about date and outputting a value based on a third number of the at least one electrically powered vehicle that uses the battery replacement apparatus on the date, and
the controller predicts the schedule based on the second vehicle number estimation model and the information about the date.

6. The server according to claim 1, wherein the controller determines, based on an SOC of the specified second battery, whether or not it is possible to respond to the request for adjustment.

7. The server according to claim 6, wherein
the controller
calculates a total chargeable amount or a total dischargeable amount of the second battery, based on the SOC of the specified second battery, and
determines, based on the total chargeable amount or the total dischargeable amount, whether or not it is possible to respond to the request for adjustment.

8. A system comprising:
a battery replacement apparatus provided with at least one battery replaceable with a battery mounted on at least one electrically powered vehicle, the battery mounted on the at least one electrically powered vehicle being first battery, the at least one battery provided in the battery replacement apparatus being second battery; and
a server that manages the battery replacement apparatus, wherein the server includes:
a communication unit that receives information about a request for adjustment of power supply-and-demand in a power grid; and
a controller that predicts a schedule of replacement of the first battery at the battery replacement apparatus, and
the controller
specifies, based on the schedule, the second battery available for charging or discharging for the request for adjustment, and
determines, based on the specified second battery, whether or not it is possible to respond to the request for adjustment.

9. A management method for managing a battery replacement apparatus provided with at least one battery replaceable with a battery mounted on at least one electrically powered vehicle, the battery mounted on the at least one electrically powered vehicle being first battery, the at least one battery provided in the battery replacement apparatus being second battery, the management method comprising:
receiving information about a request for adjustment of power supply-and-demand in a power grid;
predicting a schedule of replacement of the first battery at the battery replacement apparatus;
specifying, based on the schedule, the second battery available for charging or discharging for the request for adjustment; and
determining, based on the specified second battery, whether or not it is possible to respond to the request for adjustment.
